(19) United States
(12) Patent Application Publication
(10) Pub. No.: US 2025/0253597 A1
(43) Pub. Date: Aug. 7, 2025

(54) Connector Housing Assembly and Connector

(71) Applicant: Tyco Electronics (Shanghai) Co., Ltd., Shanghai (CN)

(72) Inventors: Hua He, Shanghai (CN); Yong (Chris) Wang, Shanghai (CN); Yingchun (David) Wang, Shanghai (CN); Guoqiang (David) Li, Shanghai (CN)

(73) Assignee: Tyco Electronics (Shanghai) Co., Ltd., Shanghai (CN)

(21) Appl. No.: 19/042,412

(22) Filed: Jan. 31, 2025

(30) Foreign Application Priority Data
Feb. 1, 2024 (CN) 202410147180.X

(51) Int. Cl. H01R 13/74

(52) U.S. Cl. CPC H01R 13/74

(57) ABSTRACT

A connector housing assembly includes a base fixed to an installation panel and having an inner cavity, a housing having a first end inserted into the inner cavity, and a spring axially compressed between the first end of the housing and the base. The housing floats relative to the base between a pre-installation position and a final installation position. An internal gear is formed on an inner peripheral surface of the base and an external gear meshing with the internal gear is formed on an outer peripheral surface of the first end of the housing. The internal gear meshes with the external gear and prevents the housing from rotating relative to the base when the housing is in the final installation position. The internal gear is separated from the external gear and allows the housing to rotate relative to the base when the housing is in the pre-installation position.

### CROSS-REFERENCE TO RELATED APPLICATION

This application claims the benefit of the filing date under 35 U.S.C. § 119 (a)-(d) of Chinese Patent Application No. 202410147180.X, filed on Feb. 1, 2024.

### FIELD OF THE INVENTION

The present invention relates to a connector housing assembly and a connector comprising the connector housing assembly.

### BACKGROUND OF THE INVENTION

A housing of a connector is often fastened to an installation panel using bolts.

Subsequently, after being installed on the installation panel, the housing of the connector cannot be rotated relative to the installation panel. However, in some applications, the orientation (or angle) of the connector housing needs to be adjusted. Existing connectors are not suitable for this situation, which limits the application range of the connectors.

### SUMMARY OF THE INVENTION

A connector housing assembly includes a base fixed to an installation panel and having an inner cavity, a housing having a first end inserted into the inner cavity, and a spring axially compressed between the first end of the housing and the base. The housing floats relative to the base between a pre-installation position and a final installation position. An internal gear is formed on an inner peripheral surface of the base and an external gear meshing with the internal gear is formed on an outer peripheral surface of the first end of the housing. The internal gear meshes with the external gear and prevents the housing from rotating relative to the base when the housing is in the final installation position. The internal gear is separated from the external gear and allows the housing to rotate relative to the base when the housing is in the pre-installation position.

### BRIEF DESCRIPTION OF DRAWINGS

The invention will now be described by way of example with reference to the accompanying figures, of which:

FIG. 1 is a perspective view of a connector housing assembly according to an exemplary embodiment;

FIG. 2 is a partial exploded view of the connector housing assembly of FIG. 1;

FIG. 3 is another partial exploded view of the connector housing assembly of FIG. 1 showing a housing, a spring, and a blocking washer of the connector housing assembly;

FIG. 4 is an axial sectional view of the view of FIG. 2 of the connector housing assembly of FIG. 1;

FIG. 5 is a sectional view of the connector housing assembly of FIG. 1 with the connector housing in a final installation position; and

FIG. 6 is a sectional view of the connector housing of FIG. 1 with the connector housing in a pre-installation position.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing(s).

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

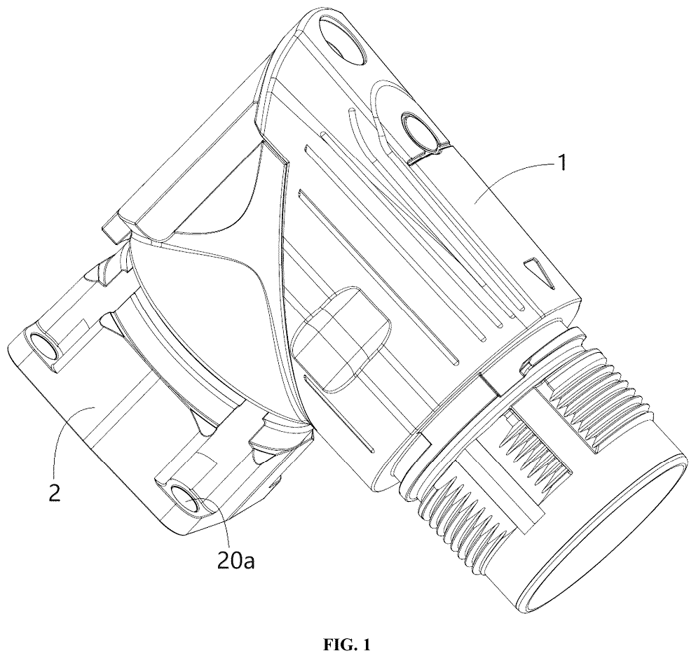

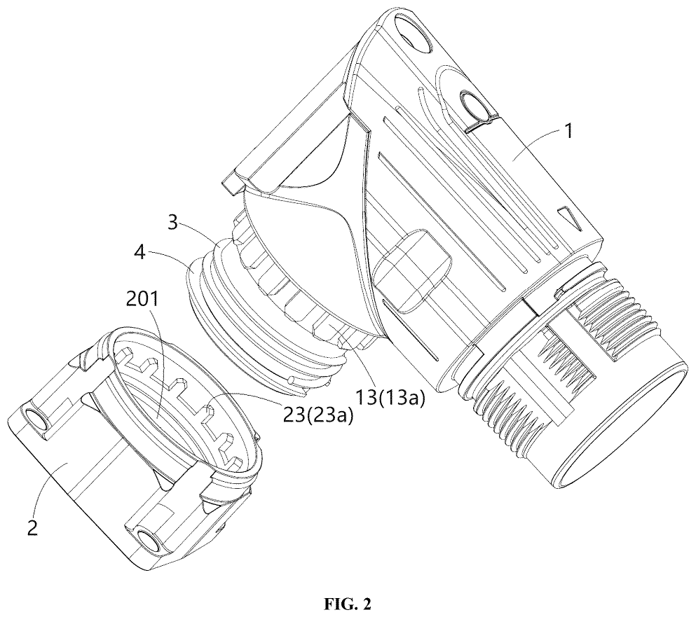

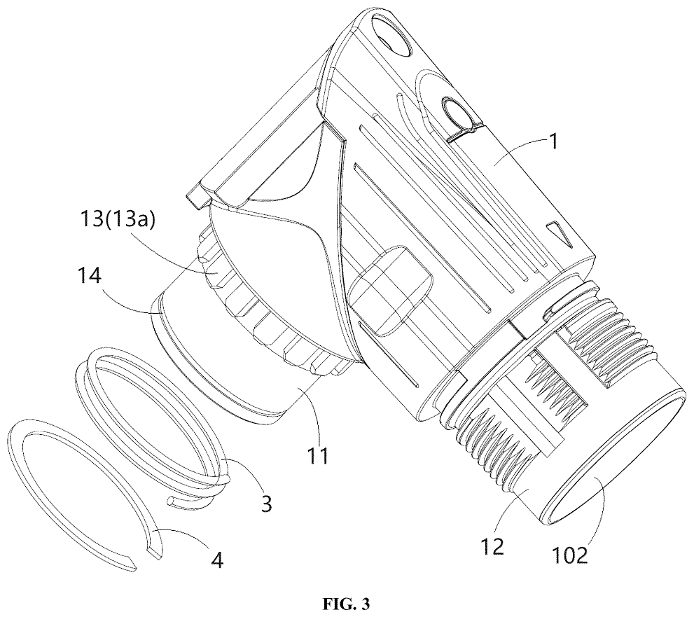

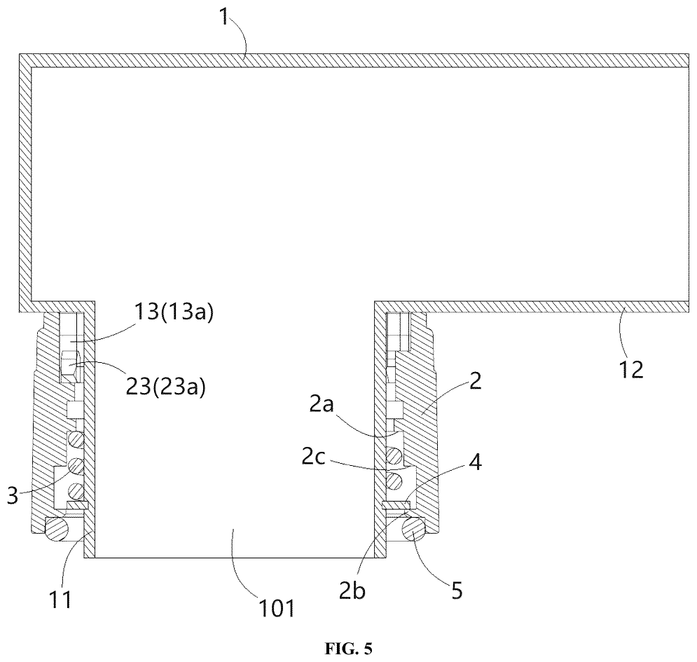

A connector housing assembly according to an exemplary embodiment shown in FIGS. 1-6 is now described. The connector housing assembly, as shown in FIGS. 2, and 4-5, comprises a housing 1, a base 2, and a spring 3. The base 2 is adapted to be fixed to an installation panel and formed with a hollow inner cavity 201, as shown in FIG. 2. The housing 1 has a first end 11, as shown in FIGS. 3 and 5, adapted to be inserted into the inner cavity 201 of the base 2 along the axial direction of the inner cavity 201. The spring 3 is axially compressed between the first end 11 of the housing 1 and the base 2, allowing the housing 1 to float relative to the base 2 along the axial direction of the inner cavity 201 between a pre-installation position and a final installation position.

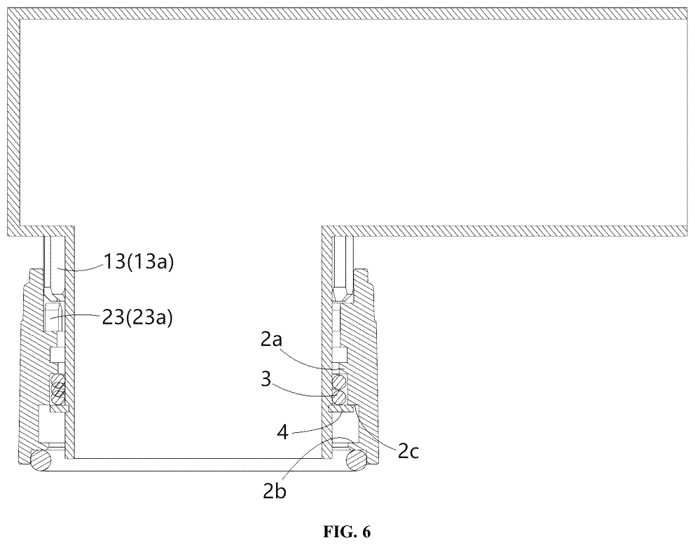

As shown in FIGS. 2, and 4-6, an internal gear 23 is formed on the inner peripheral surface of the base 2, and an external gear 13 suitable for meshing with the internal gear 23 is formed on the outer peripheral surface of the first end 11 of the housing 1. When the housing 1 is in the final installation position, as shown in FIG. 5, the internal gear 23 meshes with the external gear 13 to prevent the housing 1 from being rotated relative to the base 2 about the axis of the inner cavity 201. When the housing 1 is in the pre-installation position, as shown in FIG. 6, the internal gear 23 separates from the external gear 13 to allow the housing 1 to rotate relative to the base 2 about the axis of the inner cavity 201. Therefore, in the present invention, after the connector is installed on the installation panel, the housing 1 of the connector can be rotated relative to the installation panel, so that the orientation of the housing 1 of the connector can be adjusted according to actual needs, expanding the application range of the connector.

The housing 1 is adapted to automatically reset from the pre-installation position, as shown in FIG. 6, to the final installation position, as shown in FIG. 5, under the elastic restoring force of the spring 3. Therefore, in the illustrated embodiment, after rotating the housing 1 of the connector to a predetermined orientation, once the housing 1 is released, it will automatically reset from the pre-installation position to the final installation position under the elastic reset force of the spring 3, thereby making the connector housing assembly more convenient to use.

As shown in FIG. 5, when the housing 1 is in the final installation position, the spring 3 applies a predetermined axial thrust on the housing 1 to keep it in the final installation position.

As shown in FIGS. 2-6, the external gear 13 has multiple first teeth 13a, which are evenly spaced in the circumferential direction of the first end 11 of the housing 1. The internal gear 23, as shown in FIGS. 2, and 4-6, has multiple second gear teeth 23a, which are evenly spaced in the circumferential direction of the inner cavity 201 of the base 2. Each first gear tooth 13a is adapted to be engaged in a tooth gap between adjacent two second gear teeth 23a, and each second gear tooth 23a is adapted to be engaged in the tooth gap between adjacent two first gear teeth 13a.

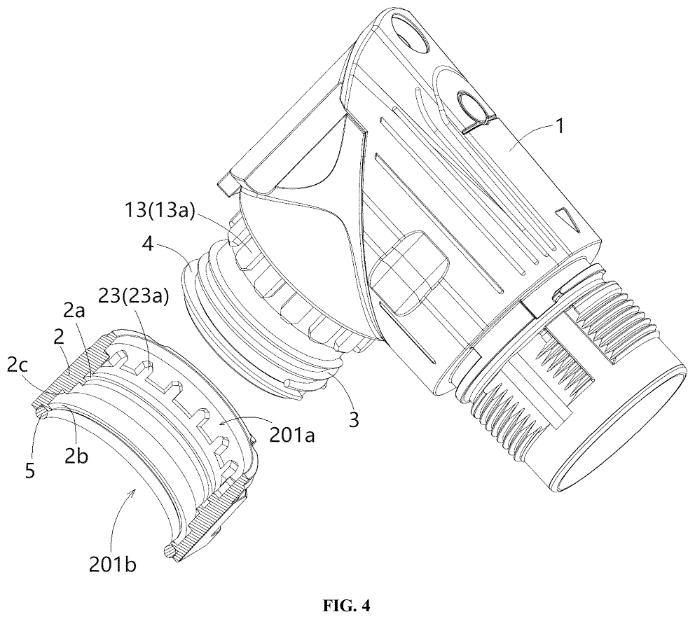

As shown in FIGS. 2 and 4, the inner cavity 201 of the base 2 has a top opening 201a and a bottom opening 201b that are opposite in its axial direction. As shown in FIG. 5, the first end 11 of the housing 1 is inserted into the inner cavity 201 of the base 2 from the top opening 201a of the base 2. The internal gear 23, as shown in FIG. 4, is close to the top opening 201a of the base 2.

As shown in FIGS. 4-6, a blocking flange 2a is formed on the inner peripheral surface of the base 2. A snap slot 14, as shown in FIG. 3, is formed on the outer peripheral surface of the first end 11 of the housing 1. The connector housing assembly also includes a blocking washer 4, as shown in FIGS. 2-6, which is snapped in the snap slot 14 of the first end 11 of the housing 1. The upper and lower ends of the spring 3, as shown in FIG. 6, are respectively pressed against the blocking flange 2a and the blocking washer 4, causing the spring 3 to be axially compressed between the first end 11 of the housing 1 and the base 2.

As shown in FIG. 3, the blocking washer 4 is in the form of a C-shaped ring, allowing the blocking washer 4 to undergo elastic deformation in the radial direction.

As shown in FIGS. 3-4, the spring 3 is in a spiral shape and is fitted onto the first end 11 of the housing 1. However, the shape of spring 3 is not limited to the illustrated embodiment and can be other suitable shapes of elastic components.

As shown in FIGS. 5-6, an upper limit step 2c and a lower limit step 2b are also formed on the inner peripheral surface of the base 2, which are opposite to each other in the axial direction of the inner cavity 201. When the housing 1 is in the final installation position, as shown in FIG. 5, the lower limit step 2b is pressed against the blocking washer 4 to restrict the housing 1 in the final installation position. When the housing 1 is in the pre-installation position, as shown in FIG. 6, the upper limit step 2c rests against the blocking washer 4 to restrict the housing 1 in the pre-installation position.

As shown in FIG. 4, the lower limit step 2b is located near the bottom opening 201b of the inner cavity 201 of the base 2, and the blocking flange 2a is located above the upper limit step 2c and spaced apart from it by a predetermined distance in the axial direction.

As shown in FIGS. 4-5, the connector housing assembly further comprises a sealing ring 5, which is arranged on the lower end surface of the base 2 and is suitable for being compressed between the base 2 and the installation panel to achieve sealing between the two.

As shown in FIG. 4, a sealing ring installation groove is formed on the lower end surface of the base 2, and the sealing ring 5 is installed in the sealing ring installation groove.

As shown in FIG. 1, a connection hole 20a is formed in the base 2 to allow a threaded connection member (such as a bolt or screw) to pass through, so that the base 2 can be fastened to the installation panel through the threaded connection member passing through the connection hole 20a.

A connector according to an exemplary embodiment is now described. The connector includes the connector housing assembly according to FIGS. 1-6, as described above, an insulator, and a terminal. The insulator is provided in the housing 1. The terminal is held in the housing 1 by the insulator.

As shown in FIG. 5, the housing 1 has a first port 101 located at the first end 11. The terminal has a connection end located in the first port 101 of the housing 1. The connection end of the terminal is used to electrically connect with a cable extending into the first port 101.

As shown in FIG. 3, the housing 1 also has a second end 12 and a second port 102 located in the second end 12. The terminal has a mating end located in the second port 102 of the housing 1, and the mating end of the terminal is used to mate with a mating terminal of a mating connector inserted into the second port 102.

As shown in FIG. 3, the axial direction of the first end 11 of the housing 1 is perpendicular to the axial direction of the second end 12 of the housing 1, resulting in the housing 1 being L-shaped.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A connector housing assembly, comprising:
a base fixed to an installation panel and having an inner cavity;
a housing having a first end inserted into the inner cavity along an axial direction of the inner cavity; and
a spring axially compressed between the first end of the housing and the base, the housing floats relative to the base along the axial direction between a pre-installation position and a final installation position, an internal gear is formed on an inner peripheral surface of the base and an external gear meshing with the internal gear is formed on an outer peripheral surface of the first end of the housing, the internal gear meshes with the external gear and prevents the housing from rotating relative to the base about an axis of the inner cavity when the housing is in the final installation position, the internal gear is separated from the external gear and allows the housing to rotate relative to the base about the axis of the inner cavity when the housing is in the pre-installation position.

2. The connector housing assembly of claim 1, wherein an elastic restoring force of the spring automatically resets the housing from the pre-installation position to the final installation position, the spring applies a predetermined axial thrust on the housing to keep the housing in the final installation position when the housing is in the final installation position.

3. The connector housing assembly of claim 1, wherein the external gear has a plurality of first teeth, the first teeth are evenly spaced in a circumferential direction of the first end of the housing, and the internal gear has a plurality of second teeth, the second teeth are evenly spaced in a circumferential direction of the inner cavity of the base.

4. The connector housing assembly of claim 3, wherein each first tooth engages in a tooth gap between two adjacent second teeth, and each second tooth engages in a tooth gap between two adjacent first teeth.

5. The connector housing assembly of claim 1, wherein the inner cavity of the base has a top opening and a bottom opening opposite each other in an axial direction of the inner cavity, the first end of the housing is inserted into the inner cavity of the base from the top opening, the internal gear is adjacent to the top opening.

6. The connector housing assembly of claim 5, wherein a blocking flange is formed on the inner peripheral surface of the base, and a snap slot is formed on the outer peripheral surface of the first end of the housing.

7. The connector housing assembly of claim 6, further comprising a blocking washer, the blocking washer is snapped into the snap slot of the housing.

8. The connector housing assembly of claim 7, wherein an upper end and a lower end of the spring are respectively pressed against the blocking flange and the blocking washer such that the spring is axially compressed between the first end of the housing and the base.

9. The connector housing assembly of claim 7, wherein the blocking washer is a C-shaped ring.

10. The connector housing assembly of claim 1, wherein the spring is spiral shaped and is fitted onto the first end of the housing.

11. The connector housing assembly of claim 7, wherein an upper limit step and a lower limit step opposite in the axial direction are formed on the inner peripheral surface of the base.

12. The connector housing assembly of claim 11, wherein, when the housing is in the final installation position, the lower limit step rests against the blocking washer to restrict the housing in the final installation position, and when the housing is in the pre-installation position, the upper limit step rests against the blocking washer to restrict the housing in the pre-installation position.

13. The connector housing assembly of claim 11, wherein the lower limit step is adjacent the bottom opening of the inner cavity of the base, and the blocking flange is above the upper limit step and is spaced a predetermined distance from the upper limit step in the axial direction.

14. The connector housing assembly of claim 1, further comprising a sealing ring disposed on a lower end face of the base and compressed between the base and the installation panel to form a seal between the base and the installation panel.

15. The connector housing assembly of claim 14, wherein a sealing ring installation groove is formed on a lower end surface of the base, the sealing ring is installed in the sealing ring installation groove.

16. The connector housing assembly of claim 1, wherein a connection hole is formed in the base, a threaded connection member passing through the connection hole fastens the base to the installation panel.

17. A connector, comprising:
a connector housing assembly, comprising:
a base fixed to an installation panel and having an inner cavity;
a housing having a first end inserted into the inner cavity along an axial direction of the inner cavity; and
a spring axially compressed between the first end of the housing and the base, the housing floats relative to the base along the axial direction between a pre-installation position and a final installation position, an internal gear is formed on an inner peripheral surface of the base and an external gear meshing with the internal gear is formed on an outer peripheral surface of the first end of the housing, the internal gear meshes with the external gear and prevents the housing from rotating relative to the base about an axis of the inner cavity when the housing is in the final installation position, the internal gear is separated from the external gear and allows the housing to rotate relative to the base about the axis of the inner cavity when the housing is in the pre-installation position;
an insulator disposed in the housing; and
a terminal held in the housing by the insulator.

18. The connector of claim 17, wherein the housing has a first port located in the first end, and the terminal has a connection end located in the first port, the connection end of the terminal electrically connects with a cable extending into the first port.

19. The connector of claim 18, wherein the housing has a second end and a second port located in the second end, the terminal has a mating end located in the second port, the mating end of the terminal mates with a mating terminal of a mating connector inserted into the second port.

20. The connector of claim 19, wherein the housing is L-shaped, and an axial direction of the first end of the housing is perpendicular to an axial direction of the second end of the housing.
